(19) United States
(12) Patent Application Publication
(10) Pub. No.: US 2026/0052180 A1
(43) Pub. Date: Feb. 19, 2026

(54) DYNAMIC AGENT TYPE INSTANTIATION FOR PROBING INTERNAL AND EXTERNAL TARGETS

(71) Applicant: Cisco Technology, Inc., San Jose, CA (US)

(72) Inventors: Andrea Di Pietro, Parasols (FR); Sukrit Dasgupta, Norfolk, MA (US)

(73) Assignee: Cisco Technology, Inc., San Jose, CA (US)

(21) Appl. No.: 18/807,219

(22) Filed: Aug. 16, 2024

(51) Int. Cl. H04L 67/1061; H04L 43/0829; H04L 43/0852; H04L 43/087; H04L 45/02

(52) U.S. Cl. CPC H04L 67/1061; H04L 43/0829; H04L 43/0858; H04L 43/087; H04L 45/02

(57) ABSTRACT

In one implementation, a device identifies paths in a network between a plurality of endpoint probing agents in the network and an external probing agent. The device selects, based on the paths, a subset of endpoint probing agents from among the plurality of endpoint probing agents whose paths to the external probing agent do not overlap in the network. The device configures the subset of endpoint probing agents to perform path probing within the network towards the external probing agent. The device forms aggregated probing results by aggregating path probing results from the external probing agent probing a destination external to the network with path probing results from the subset of endpoint probing agents within the network.

### TECHNICAL FIELD

The present disclosure relates generally to computer systems, and, more particularly, to dynamic agent type instantiation for probing internal and external targets.

### BACKGROUND

Traditionally, path probing has allowed network administrators and route selection mechanisms to assess the performance of the various network paths that are available to a given destination, such as the loss, latency, or jitter along a given path. To do so, path probing entails sending probe packets along the target paths, to record information such as whether the packet reached its destination, how long it took for the packet to traverse the path and/or each hop along the path, etc.

Currently, both enterprise and endpoint agents all perform active probing tests targeting services and endpoints on the public network. Most of the time, these tests are redundant, as multiple agents probe the same path on the public network at the same time. In fact, for most of the performed tests, the additional value is in the data covering the internal path leading to the edge of the enterprise network, which is potentially different for each agent.

In addition, the number of external services and the frequency of tests for each agent should be limited, in order to make the aggregated number of probes manageable. Also, in terms of entitlement usage, it is more optimal to use the agents providently and get visibility on non-overlapping paths of the network.

### BRIEF DESCRIPTION OF THE DRA WINGS

The implementations herein may be better understood by referring to the following description in conjunction with the accompanying drawings in which like reference numerals indicate identically or functionally similar elements, of which:

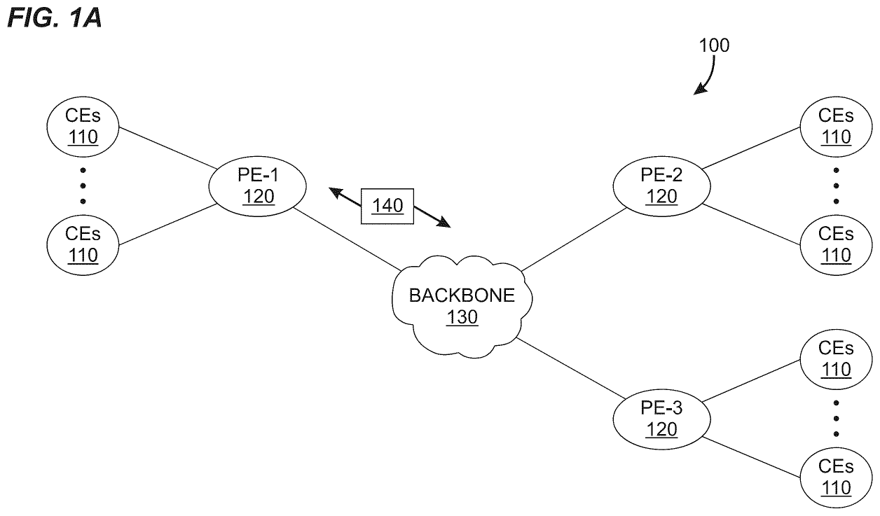

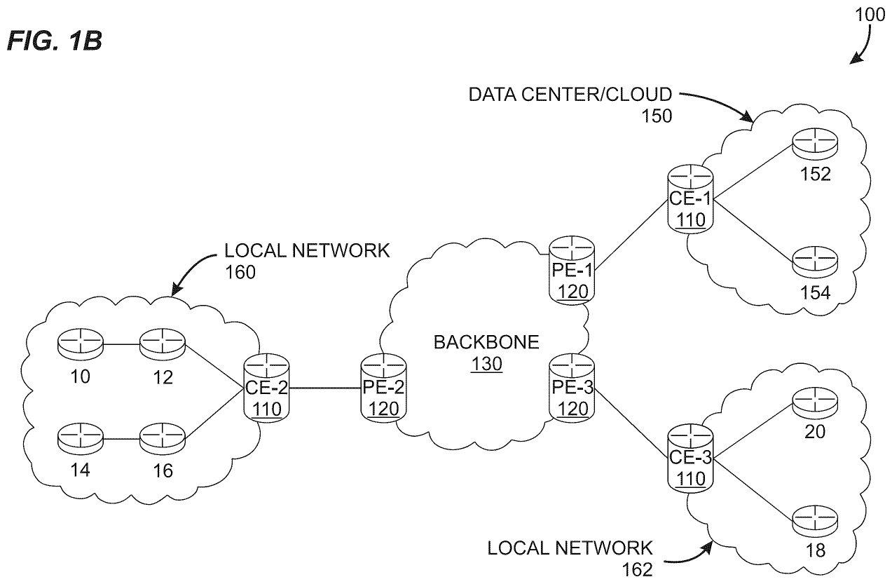

FIGS. 1A-1B illustrate an example communication network;

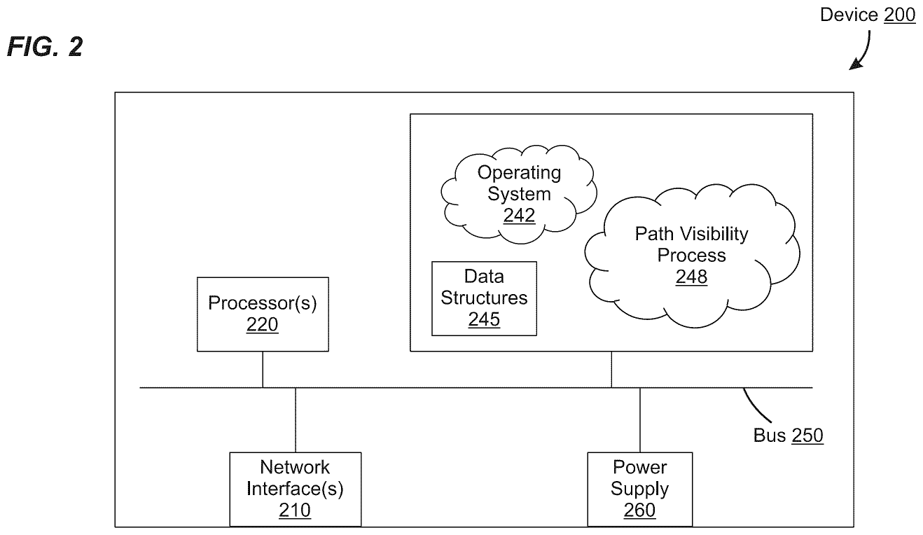

FIG. 2 illustrates an example network device/node;

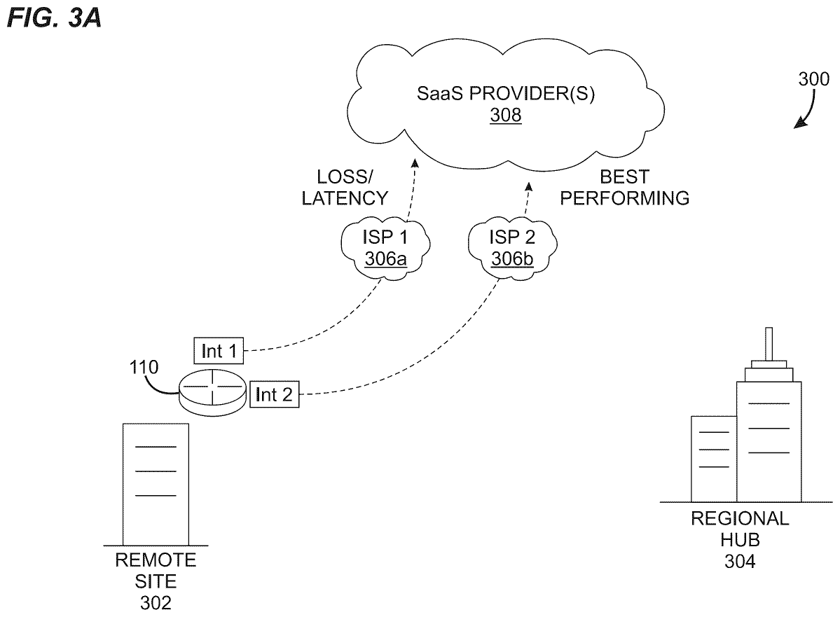

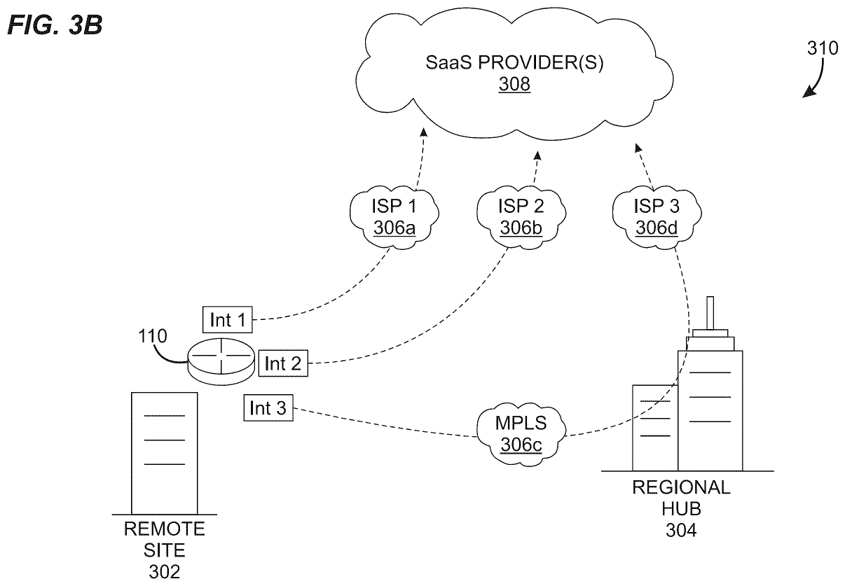

FIGS. 3A-3B illustrate example network deployments;

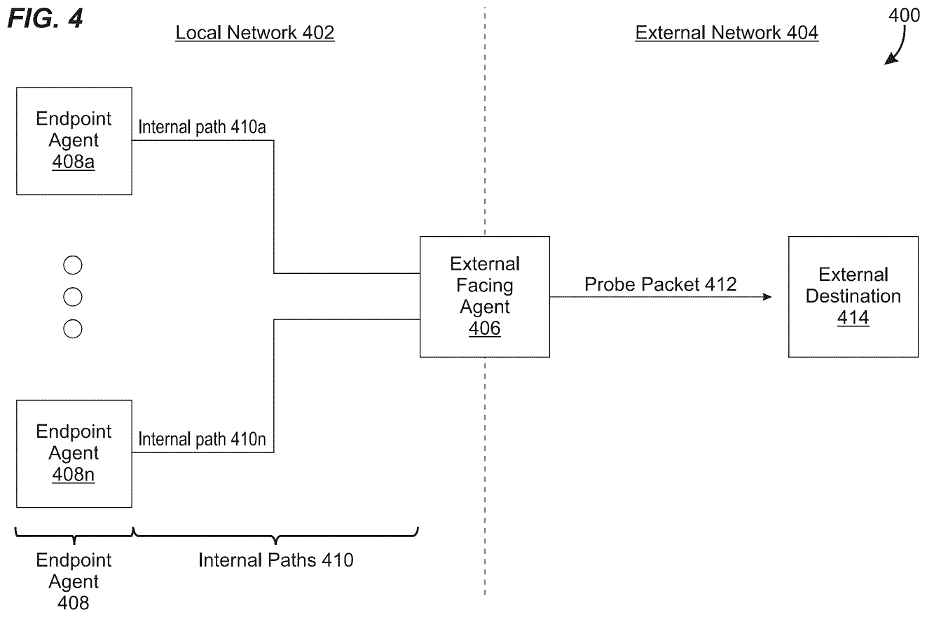

FIG. 4 illustrates an example of probing agents in a network;

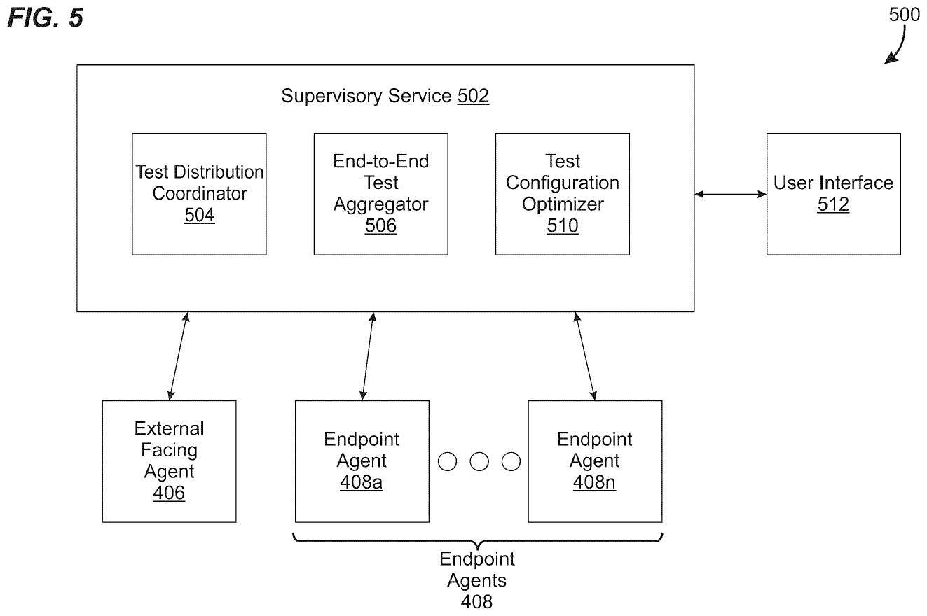

FIG. 5 illustrates an example architecture for conducting path probing using internal and external path probing agents; and

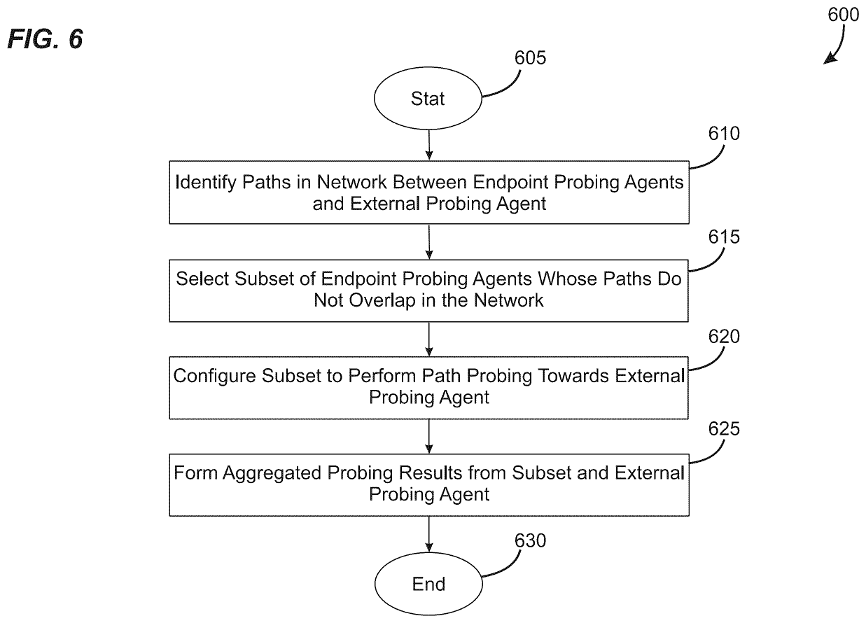

FIG. 6 illustrates an example of a simplified procedure for conducting path probing using internal and external path probing agents.

### DESCRIPTION OF EXAMPLE EMBODIMENTS

### Overview

According to one or more implementations of the disclosure, a device identifies paths in a network between a plurality of endpoint probing agents in the network and an external probing agent. The device selects, based on the paths, a subset of endpoint probing agents from among the plurality of endpoint probing agents whose paths to the external probing agent do not overlap in the network. The device configures the subset of endpoint probing agents to perform path probing within the network towards the external probing agent. The device forms aggregated probing results by aggregating path probing results from the external probing agent probing a destination external to the network with path probing results from the subset of endpoint probing agents within the network.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

FIG. 1A is a schematic block diagram of an example computer network (e.g., network 100) illustratively comprising nodes/devices, such as a plurality of routers/devices interconnected by links or networks, as shown. For example, customer edge (CE) routers (e.g., CE routers 110) may be interconnected with provider edge (PE) routers 120 (e.g., PE-1, PE-2, and PE-3) in order to communicate across a core network, such as an illustrative network backbone (e.g., network backbone 130). For example, routers (e.g., CE routers 110), routers 120 may be interconnected by the public Internet, a multiprotocol label switching (MPLS) virtual private network (VPN), or the like. Data packets 140 (e.g., traffic/messages) may be exchanged among the nodes/devices of the network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router (e.g., CE routers 110) shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection). Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., CE routers 110) connected to PE-2 and a second CE router (e.g., CE routers 110) connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks (e.g., network 160-162) that include devices/nodes 10-16 and devices/nodes 18-20, respectively, as well as a data center/cloud environment 150 that includes servers 152-154. Notably, local networks (e.g., network 160-162) and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the computing devices shown in FIGS. 1A-1B, particularly the PE routers (e.g., routers 120), CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces (e.g., network interfaces 210), one or more processors (e.g., processor(s) 220), and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor (e.g., processor(s) 220) may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a path visibility process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In some instances, path visibility process 248 may include computer executable instructions executed by the processor (e.g., processor(s) 220) to establishing network path visibility using an intelligent network path probing technique and/or to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, path visibility process 248 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, path visibility process 248 may include computer executable instructions that, when executed by processor(s) 220, cause device 200 to perform the techniques described herein. To do so, in some implementations, path visibility process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, path visibility process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the path visibility process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further embodiments, process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact on the overall Internet due to the extreme virtualization of services and shift of traffic load in many large enterprises. Consequently, a branch office or a campus can trigger massive loads on the network.

FIGS. 3A-3B illustrate examples of network deployments 300, 310, respectively. As shown, a router (e.g., CE routers 110) located at the edge of a remote site 302 may provide connectivity between a local area network (LAN) of the remote site 302 and one or more cloud-based, SaaS providers (e.g., provider(s) 308). For example, in the case of an SD-WAN, router (e.g., CE routers 110) may provide connectivity to SaaS provider(s) (e.g., provider(s) 308) via tunnels across any number of networks 306. This allows clients located in the LAN of remote site 302 to access cloud applications (e.g., Office 365™, Dropbox™, etc.) served by SaaS provider(s) (e.g., provider(s) 308).

As would be appreciated, SD-WANs allow for the use of a variety of different pathways between an edge device and a SaaS provider. For example, as shown in example network deployment 300 in FIG. 3A, router (e.g., CE routers 110) may utilize two Direct Internet Access (DIA) connections to connect with SaaS provider(s) 308. More specifically, a first interface of router (e.g., CE routers 110) (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router (e.g., CE routers 110), Int 2, may establish a backhaul path with SaaS provider(s) 308 via a second ISP 306b, denoted ISP 2 in FIG. 3A.

FIG. 3B illustrates another example network deployment 310 in which Int 1 of (e.g., CE routers 110) at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router (e.g., CE routers 110) may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

As noted above, path probing has allowed network administrators and route selection mechanisms to assess the performance of the various network paths that are available to a given destination, such as the loss, latency, or jitter along a given path. To do so, path probing entails sending probe packets along the target paths, to record information such as whether the packet reached its destination, how long it took for the packet to traverse the path and/or each hop along the path, etc.

For instance, in the case of FIG. 3B, multiple paths are available from remote site 302 and an SaaS provider 308. This means that an endpoint device in the local network of remote site 302 can connect to the SaaS application over any of these paths, each of which may offer different degrees of performance. In some cases, the performance of the selected path can even impinge on the application experience of the user, leading to poor application performance. For instance, consider the case in which the user connects to a videoconferencing application. If the selected path exhibits high loss or jitter, this could lead to the video and/or audio freezing for the user.

To determine the performance of a given path so that the best path can be selected for the application traffic, a path probing agent may send probe packets along the various paths to SaaS provider 308. Currently, both enterprise and endpoint agents all perform active probing tests targeting services and endpoints on the public network. For instance, a probing agent on CE router 110 as well as a probing agent on the endpoint device of the user that is to connect to SaaS provider 308 may perform probing.

One observation herein is that most of the time, these tests are redundant, as multiple agents probe the same path on the public network at the same time. In fact, for most of the performed tests, the additional value is in the data covering the internal path leading to the edge of the enterprise network, which is potentially different for each agent. For instance, consider the case in which multiple endpoints in remote site 302 each perform probing with respect to SaaS provider 308. In such a case, the external paths that these endpoints will end up probing are the same set of paths, meaning that these probing tests are largely redundant.

In addition, the number of external services and the frequency of tests for each agent should be limited, in order to make the aggregated number of probes manageable. Also, in terms of entitlement usage, it is more optimal to use the agents providently and get visibility on non-overlapping paths of the network.

### —Dynamic Agent Type Instantiation for Probing Internal and External Targets—

The techniques introduced herein allow for reducing the redundancy implied by several agents performing active probing towards the same destination. In various implementations, the techniques herein do so by having endpoint agents perform active probing towards an external facing agent, deployed at the edge of the enterprise network. In addition, the external facing agent may only perform the active probing towards the external destination. In turn, the techniques introduced herein merge the results of the two probing processes, allowing the results to be presented to a user via a user interface as a single end-to-end value.

Illustratively, the techniques described herein may be performed by hardware, software, and/or firmware, such as in accordance with the path visibility process 248, which may include computer executable instructions executed by the processor (e.g., processor(s) 220) (or independent processor of interfaces (e.g., network interfaces 210)) to perform functions relating to the techniques described herein.

Specifically, according to one or more implementations of the disclosure as described in detail below, a device identifies paths in a network between a plurality of endpoint probing agents in the network and an external probing agent. The device selects, based on the paths, a subset of endpoint probing agents from among the plurality of endpoint probing agents whose paths to the external probing agent do not overlap in the network. The device configures the subset of endpoint probing agents to perform path probing within the network towards the external probing agent. The device forms aggregated probing results by aggregating path probing results from the external probing agent probing a destination external to the network with path probing results from the subset of endpoint probing agents within the network.

Operationally and according to various implementations, FIG. 4 illustrates an example 400 of probing agents in a network. As shown, assume that there is a local network 402 in which there are n-number of endpoint agents 408 (e.g., a first endpoint agent 408a through an nth endpoint probing agent 408n). Each of endpoint agents 408 may be executed by its own corresponding endpoint (e.g., a personal computer, a tablet, a wearable device, a smartphone, etc.).

Local network 402 may be connected to an external network 404, such as the Internet, an MPLS network, or the like. As noted above, there may be any number of edge devices in local network 402 (e.g., CE routers, etc.) to form this connection.

In various implementations, the techniques herein introduce an external facing agent 406 located at the edge of local network 402. Typically, an edge device may execute external facing agent 406. In some implementations, external facing agent 406 may be a subclass of an existing enterprise agent and is only installed at the edge of the enterprise network. Generally, the goal of external facing agent 406 is to probe the network path in external network 404 from the edge of the network to the public services to be tested.

Preferably, to eliminate or reduce redundant probing, external facing agent 406 is the only agent performing active tests against public endpoints via external network 404. Since the number of agents probing external services/destinations using this approach would be limited, a larger number of tests can be scheduled while maintaining the overall traffic used for active probing manageable and not have multiple redundant measurements.

More specifically, assume that each of endpoint agents 408 is located along a different network path within local network 402 with respect to external facing agent 406. For instance, first endpoint agent 408a may be located along internal path 410a whereas nth endpoint probing agent 408n may be located along internal path 410n, both of which extend to the device hosting external facing agent 406. Rather than each of endpoint agents 408 issuing probe packets towards an external destination 414, the techniques herein provide for endpoint agents 408 to only conduct probing internal to local network 402 and external facing agent 406 being responsible for sending a probe packet 412 towards external destination 414 via external network 404. In turn, the system may combine the results of both probing tests, to produce the end-to-end probing results. For instance, if the system combines the probing results of first endpoint agent 408a probing internal path 410a to external facing agent 406 and the probing results from probe packet 412 sent towards external destination 414, this will result in the end-to-end path metrics between first endpoint agent 408a and external destination 414.

FIG. 5 illustrates an example architecture 500 for conducting path probing using internal and external path probing agents, according to various implementations. As shown, the techniques herein introduce a supervisory service 502 that may be executed by any device either internally or externally to a network (e.g., any device 200 through execution of path visibility process 248). During execution, supervisory service 502 may be responsible for providing control over the various path probing agents in the local network (e.g., local network 402), such as external facing agent 406 and endpoint agents 408.

In various implementations, supervisory service 502 (e.g., path visibility process 248) may include a variety of components such as any or all of the following: a test distribution coordinator 504, an end-to-end test aggregator 506, and/or a test configuration optimizer 508. These components may be combined, included, or excluded, as desired. In addition, in cases in which the components shown are executed in a distributed manner, their executing devices may be viewed as a singular device for purposes of the teachings herein.

During execution, test distribution coordinator 504 may take as input any or all of the following information, either on a pull or push basis:
The network topology
Routing information
The location of the deployed active probing agents
Any tests specified by the system administrator
Optionally, a system administrator could also define some policies via a user interface 512 to specify which tests can be executed by external facing agent 406 and which need to be carried out atomically from any of endpoint agents 408 to the external service.

Based on such information, test distribution coordinator 504 may generate a set of configurations for both external facing agent 406 and endpoint agents 408. In various implementations, the probing tests conducted by endpoint agents 408 may only cover any or all of the following:
the path from their location to the external facing agent
the internal network services (DHCP, AAA etc.)
internal interfaces on distribution switches
key fork points in the enterprise network

Additionally, test distribution coordinator 504 may configure external facing agent 406 to conduct probing of the portion of the path from the network edge to the public endpoint.

For example, if the test specifies targeting an external HTTP server every minute from ten internal endpoint agents 408, test distribution coordinator 504 may configure such internal agents to ping external facing agent 406 every minute and configure the latter to perform a test towards the HTTP server with the same frequency. This will prevent the ten internal agents from probing the same external network path at the same time. The internal to external agent probing can be implemented using purely an internal mechanism of keep-alive messages, so as to not inundate the network with probes.

In some instances, test distribution coordinator 504 may configure such tests upon interaction with the active monitoring infrastructure. For instance, in the case of ThousandEyes probing agents, the specific REST API can be used.

Test distribution coordinator 504 may also be in charge of scaling up the number of external facing agents, to make sure that the number of tests does not exceed their available resources. In other words, test distribution coordinator 504 may optionally deploy and/or configure one or more additional external facing agents, in addition to that of external facing agent 406. In various implementations, test distribution coordinator 504 may do so by doing any or all of the following:
Dynamically tracking the load on the active external facing agent(s), such as external facing agent 406. Test distribution coordinator 504 may also configure a maximum limit of internal endpoint agents 408, so that more instances can be provisioned on the fly if required.
Provision and deploy additional external facing agents
Assign to each of them a subset of the external facing tests
Assign each of the external facing agents as a test target for a subset of the internal network agents.

If the network includes a large number of endpoint agents 408, with many of them frequently leaving the network and reappearing in another location (such as in a wireless network), dynamically tracking reconfiguring each of them can be cumbersome for the test distribution coordinator 504. In order to alleviate this issue, in another implementation, a distributed mechanism for the discovery of external facing agents can be used.

Test distribution coordinator 504 may provide each of the enterprise agents, such as external facing agent 406, with the address of the external facing endpoint to be used for its tests.

On connecting to a new network, an endpoint agent 408 may also send a custom Layer-2 broadcast message to request an external facing agent. If an enterprise agent is reachable on the same Layer-2 network, it will respond with a custom “external facing agent response” message, including the address of its assigned external facing agent(s), along with a new test configuration from test distribution coordinator 504 including the local services to be probed.

When the deployment procedure is finished, the internal network agents 408 and the endpoint facing agent(s) may report the results of their own tests independently. To this end, end-to-end test aggregator 506 may be configured to aggregate the probing results into an end-to-end test result for each deployed agent. More specifically, end-to-end test aggregator 506 may process the results of the tests performed by the different agent types and provide a single end to end result for each agent.

In particular, for each internal network agent, the end-to-end value of a path metric for a given test will be the combination of the metric (e.g., delay, loss, jitter) for the path from the internal network agent to the external facing agent and the path metric for the path from the external facing agent to the public endpoint. For example, the latency from a laptop with an installed endpoint agent to a Webex server will consist of the sum of the latency between the laptop and the external facing agent and the latency between the external facing agent and the Webex server.

Since such measurements will not be performed at the same time (each of the two latencies will be measured independently), end-to-end test aggregator 506 may be in charge of applying the right solution for combining them in a statistically significant way. For instance, in the case of the end-to-end latency, the sum of the two average latencies can be shown via user interface 512. In terms of loss probability, the end-to-end loss probability is the statistical combination of the loss probability on the inner and outer path.

End-to-end test aggregator 506 may then provide the result of such aggregation to user interface 512, potentially also augmented with any relevant statistical ancillary information. For example, if averaging is done, user interface 512 may not show a point in time measurement, but rather a band with some confidence intervals.

In various implementations, test configuration optimizer 508 may be responsible for dynamically enabling or disable probing tests based on learning common network paths that may be being traversed. This allows it to disable any of endpoint agents 408 whose probing would traverse the same internal path as that of another agent among endpoint agents 408. In some implementations, once the internal and external agents have been identified, the external agent can communicate via the central communicator to disable overlapping tests on the internal agents.

Test configuration optimizer 508 may also periodically receive multiple data streams from the different internal agents. This data stream can contain all internal path hop details from all the internal agents to the external agents, the configured tests on all the agents, the movement of internal agents in the network, as well as topological updates that capture the changes taking place in the network.

With these pieces of information, test configuration optimizer 508 can compute where visibility is lost due to topology changes, where there are overlapping tests, and if new external agents need to be spawned to obtain new visibility points. Finally, test configuration optimizer 508 may disable redundant tests or enable existing or new tests from a different external or multiple internal agents. Doing so ensures the test configurations and visibility into the services are always up-to-date and configured in the most efficient manner. Y

FIG. 6 illustrates an example simplified procedure (e.g., a method) for conducting path probing using internal and external path probing agents, in accordance with one or more implementations described herein. For example, a non-generic, specifically configured device (e.g., device 200) may perform procedure 600 by executing stored instructions (e.g., path visibility process 248). The procedure 600 may start at step 605, and continues to step 610 where, as described in greater detail above, the device may identify paths in a network between a plurality of endpoint probing agents in the network and an external probing agent. In some implementations, the device identifies a particular endpoint probing agent in the plurality of endpoint probing agents based on a broadcast message sent by that agent into the network.

At step 615, as detailed above, the device may select, based on the paths, a subset of endpoint probing agents from among the plurality of endpoint probing agents whose paths to the external probing agent do not overlap in the network. In various implementations, the external probing agent is executed by an edge networking device of the network.

At step 620, the device may configure the subset of endpoint probing agents to perform path probing within the network towards the external probing agent, as described in greater detail above. In various implementations, the device configures the subset of endpoint probing agents to perform path probing within the network periodically and based in part on a probing schedule of the external probing agent.

At step 625, as detailed above, the device may form aggregated probing results by aggregating path probing results from the external probing agent probing a destination external to the network with path probing results from the subset of endpoint probing agents within the network. For instance, the aggregated probing results may be indicative of at least one of: a path throughput, a path latency, a path jitter, or a path loss between an endpoint in the network and the destination external to the network. In turn, the device may provide the aggregated probing results to a user interface for display. In some cases, the destination external to the network is a web server or an application server. In various implementations, the device may also update the subset of endpoint probing agents to include an additional endpoint probing agent from among the plurality of endpoint probing agents. In one implementation, the device may do so in response to a detected topology change in the network. In a further implementation, the device may also provision a second external probing agent based on a load associated with the external probing agent.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for conducting path probing using internal and external path probing agents, it is to be understood that various other adaptations and modifications may be made within the spirit and scope of the implementations herein. For example, while certain implementations are described herein with respect to using certain types of probe protocols and configurations in pre-probe scan and rescan operations, the probes and their usage is not limited as such and may include other protocols and configurations that can be used for other functions, in other implementations.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
identifying, by a device, paths in a network between a plurality of endpoint probing agents in the network and an external probing agent;
selecting, by the device and based on the paths, a subset of endpoint probing agents from among the plurality of endpoint probing agents whose paths to the external probing agent do not overlap in the network;
configuring, by the device, the subset of endpoint probing agents to perform path probing within the network towards the external probing agent; and
forming, by the device, aggregated probing results by aggregating path probing results from the external probing agent probing a destination external to the network with path probing results from the subset of endpoint probing agents within the network.

2. The method as in claim 1, wherein the device configures the subset of endpoint probing agents to perform path probing within the network periodically and based in part on a probing schedule of the external probing agent.

3. The method as in claim 1, further comprising:
updating, by the device, the subset of endpoint probing agents to include an additional endpoint probing agent from among the plurality of endpoint probing agents.

4. The method as in claim 1, wherein the device updates the subset of endpoint probing agents in response to a detected topology change in the network.

5. The method as in claim 1, further comprising:
provisioning a second external probing agent based on a load associated with the external probing agent.

6. The method as in claim 1, wherein the external probing agent is executed by an edge networking device of the network.

7. The method as in claim 1, wherein the device identifies a particular endpoint probing agent in the plurality of endpoint probing agents based on a broadcast message sent by that agent into the network.

8. The method as in claim 1, wherein the aggregated probing results are indicative of at least one of: a path throughput, a path latency, a path jitter, or a path loss between an endpoint in the network and the destination external to the network.

9. The method as in claim 1, further comprising:
providing the aggregated probing results to a user interface for display.

10. The method as in claim 1, wherein the destination external to the network is a web server or an application server.

11. An apparatus, comprising:
one or more network interfaces;
a processor coupled to the one or more network interfaces and configured to execute one or more processes; and
a memory configured to store a process that is executable by the processor, the process when executed configured to:
identify paths in a network between a plurality of endpoint probing agents in the network and an external probing agent;
select, based on the paths, a subset of endpoint probing agents from among the plurality of endpoint probing agents whose paths to the external probing agent do not overlap in the network;
configure the subset of endpoint probing agents to perform path probing within the network towards the external probing agent; and
form aggregated probing results by aggregating path probing results from the external probing agent probing a destination external to the network with path probing results from the subset of endpoint probing agents within the network.

12. The apparatus as in claim 11, wherein the apparatus configures the subset of endpoint probing agents to perform path probing within the network periodically and based in part on a probing schedule of the external probing agent.

13. The apparatus as in claim 11, wherein the process when executed is further configured to:
update the subset of endpoint probing agents to include an additional endpoint probing agent from among the plurality of endpoint probing agents.

14. The apparatus as in claim 11, wherein the apparatus updates the subset of endpoint probing agents in response to a detected topology change in the network.

15. The apparatus as in claim 11, wherein the process when executed is further configured to:
provision a second external probing agent based on a load associated with the external probing agent.

16. The apparatus as in claim 11, wherein the external probing agent is executed by an edge networking device of the network.

17. The apparatus as in claim 11, wherein the apparatus identifies a particular endpoint probing agent in the plurality of endpoint probing agents based on a broadcast message sent by that agent into the network.

18. The apparatus as in claim 11, wherein the aggregated probing results are indicative of at least one of: a path throughput, a path latency, a path jitter, or a path loss between an endpoint in the network and the destination external to the network.

19. The apparatus as in claim 11, wherein the process when executed is further configured to:
provide the aggregated probing results to a user interface for display.

20. A tangible, non-transitory, computer-readable medium storing program instructions that cause a device to execute a process comprising:
identifying, by the device, paths in a network between a plurality of endpoint probing agents in the network and an external probing agent;
selecting, by the device and based on the paths, a subset of endpoint probing agents from among the plurality of endpoint probing agents whose paths to the external probing agent do not overlap in the network;
configuring, by the device, the subset of endpoint probing agents to perform path probing within the network towards the external probing agent; and
forming, by the device, aggregated probing results by aggregating path probing results from the external probing agent probing a destination external to the network with path probing results from the subset of endpoint probing agents within the network.
